(19) United States
(12) Patent Application Publication
(10) Pub. No.: US 2017/0216742 A1
(43) Pub. Date: Aug. 3, 2017

(54) INLINE INSERT MOLDED FILTER ASSEMBLY

(71) Applicant: Parker-Hannifin Corporation, Cleveland, OH (US)

(72) Inventors: Andrew Prine, Waterville, OH (US); Kenneth Luther, Toledo, OH (US)

(21) Appl. No.: 15/424,044

(22) Filed: Feb. 3, 2017

Related U.S. Application Data
(60) Provisional application No. 62/290,546, filed on Feb. 3, 2016.
(60) Provisional application No. 62/373,495, filed on Aug. 11, 2016.

(51) Int. Cl. B01D 29/01; B33Y 10/00; B01D 35/30

(52) U.S. Cl. CPC B01D 29/016; B01D 29/012; B01D 35/30; B33Y 10/00

(57) ABSTRACT

A filter assembly includes a filter housing configured as a singular unitary component defining a fluid flow passage through the filter assembly. A filter element is fixed within the housing and spaced apart from both ends of the filter housing to filter a fluid as the fluid flows through the filter housing. A method of insert molding a filter assembly includes providing a mold shaped to form the filter housing as a singular unitary component, locating a filter element in the mold at a location corresponding to where the filter element is to be fixed within the filter housing, and injection molding a molten plastic filter housing material around the filter element such that a portion of the filter element is encapsulated by the molten plastic filter housing material to form the filter housing in a manner that bonds the filter element in place within the filter housing. The filter assembly alternatively may be made by 3D printing the filter housing around the filter element.

### RELATED APPLICATIONS

This application claims the benefit of U.S. Provisional Application No. 62/290,546 filed on Feb. 3, 2016, and of U.S. Provisional Application No. 62/373,495 filed on Aug. 11, 2016, which are incorporated herein by reference.

### FIELD OF INVENTION

The present invention relates generally to inline filter assemblies, or filter assemblies that filter a fluid by being inserted inline within a fluid flow pathway to filter the fluid as the fluid flows through said pathway.

### BACKGROUND OF THE INVENTION

Generally, inline filter assemblies are filter assemblies that filter a fluid by being inserted inline within a fluid flow pathway to filter the fluid as the fluid flows through said pathway. Inline filter assemblies commonly are subjected to relatively high flow rates, such as for example 10 gallons per minute (gpm) or more. An exemplary application is using an inline filter assembly to filter a coolant flow in an electric car coolant system, although inline filter assemblies may be employed in any inline flow application having a high flow rate. The micron rating of the filter element relatedly can vary as warranted for any particular filtering application.

FIG. 1 is a drawing depicting a conventional inline filter assembly 10. A conventional filter assembly 10 typically is formed by joining a metal male member 12 and a metal female member 14 that receives the male member 12. The metal male and female members typically may be made of aluminum, and are threaded for connection with flow components of a fluid system. The joining of the two members creates a gap 16, which must be sealed such as by using an o-ring seal. A pleated filter element 18 is inserted adjacent to the boundary where the male and female members are joined. At such location, a second sealing element 20 is provided. The second sealing element also may be an o-ring seal, but more typically is configured as a metal frictional torque seal. A support disc 22 also may be provided to increase rigidity of the filter element so as to accommodate higher flow rates.

Such configuration using multiple aluminum members has disadvantages. Both members are separately manufactured and then joined together in an additional processing step, which results in a complex manufacturing process. Relatedly, the joining of the two members requires the use of multiple sealing elements to seal the gap where the two members join, and to seal the location where the filter element is placed. These disadvantages increase complexity and cost, and provide multiple points where the filter assembly can fail.

### SUMMARY OF THE INVENTION

In view of the above deficiencies, there is a need in the art for an enhanced inline filter assembly that has a simpler design with fewer failure points. The present invention provides for an insert molded inline filter assembly that is configured in a manner that reduces the cost of inline fitting style filtration for high volume applications as compared to conventional configurations. In exemplary embodiments, conventional filter elements, such as for example pleated disc filter elements, may be inserted into a specifically configured injection mold. During the molding process, the perimeter of the disc filter element may be encapsulated by molten plastic material to form a filter housing that bonds the disc filter element in place in a sealed fashion without the need to utilize additional sealing elements. The molded filter housing may be left open in the axial direction (i.e., in the direction of the fluid flow) to allow fluid to flow through the disc filter element. Connecting features, such as threads for example, also may be molded concurrently or added later through post-processing such as by conventional machining.

To form the filter assembly, the filter housing may be molded over any suitable filtration components, such as pleated disc filter elements, support discs or comparable metal inserts, mesh disc filter elements, and the like. By insert molding such filtration components into a single structure filter assembly, the cost to produce the filter assembly can be greatly reduced. The reliability of the filter assembly also is enhanced as compared to conventional configurations that require welds, o-rings, or other sealing elements that may have threads, which can corrode, fail or be damaged. The filter housing may be made of nylon or other high performance plastics that can withstand the requisite flow rates. Insert molding the filtration components into such nylon or other high performance plastics can also significantly reduce the weight of the assembly over conventional configurations, which is advantageous for manufacturing, shipping, and assembly, and for enhanced corrosion resistance.

An aspect of the invention is an inline filter assembly. In exemplary embodiments, the filter assembly may include a filter housing configured as a singular unitary component a having a first end and a second end different from the first end, and defining a fluid flow passage through the filter assembly. A filter element may be fixed within the housing and spaced apart from both of the first and second ends of the filter housing, wherein the filter element includes a filtering material that filters a fluid as the fluid flows between the first end and the second end of the filter housing. The material for molding the filter housing may be a moldable plastic material, and may in particular be moldable nylon.

Another aspect of the invention is a method of insert molding a filter assembly. In exemplary embodiments, the method of insert molding may include the steps of: providing a mold shaped to form a filter housing as a singular unitary component, the filter housing mold being configured to form the filter housing having a first end and a second end different from the first end, and defining a fluid flow passage through the filter assembly; locating a filter element in the mold at a location corresponding to where the filter element is to be fixed within the filter housing, the filter element including a filtering material to filter a fluid as the fluid flows between the first end and the second end of the filter housing; injection molding molten filter housing material into the mold and around the filter element such that a portion of the filter element is encapsulated by the molten filter housing material to form the filter housing in a manner that bonds the filter element in place within the filter housing; cooling the mold; and removing the mold to free the filter assembly comprising the filter element fixed within the filter housing. As referenced above, the material for molding the filter housing may be a moldable plastic material, and may in particular be moldable nylon.

Another aspect of the invention is a method of three dimensional (3D) printing a filter assembly. In exemplary embodiments, the 3D printing method may include the steps of: locating a filter element in a 3D printer, the filter element including a filtering material to filter a fluid as the fluid flows through the filter element; and 3D printing filter housing material around the filter element such that a portion of the filter element is encapsulated by the 3D printed filter housing material to form the filter housing in a manner that bonds the filter element in place within the filter housing, the filter housing having a first end and a second end different from the first end, and defining a fluid flow passage through the filter assembly.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto. Features that are described and/or illustrated with respect to one embodiment may be used in the same way or in a similar way in one or more other embodiments and/or in combination with or instead of the features of the other embodiments.

### BRIEF DESCRIPTION OF THE DRAWINGS

FIG. 1 is a drawing depicting a conventional inline filter assembly including multiple members that are joined together and sealed.

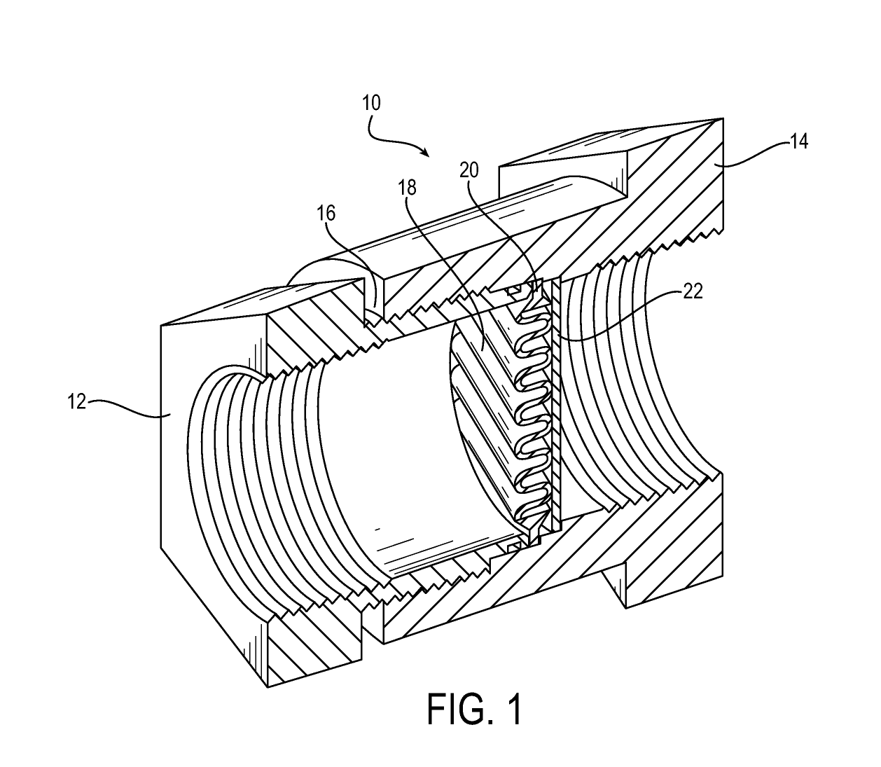

FIG. 2 is a drawing depicting an enhanced insert molded inline filter assembly in accordance with embodiments of the present invention.

FIG. 3 is a flow chart diagram depicting an exemplary method of insert molding a filter assembly in accordance with embodiments of the present invention.

FIG. 4 is a drawing depicting another embodiment of an enhanced insert molded inline filter assembly in accordance with embodiments of the present invention.

FIG. 5 is a drawing depicting yet another embodiment of an enhanced insert molded inline filter assembly in accordance with embodiments of the present invention.

### DETAILED DESCRIPTION

Embodiments of the present invention will now be described with reference to the drawings, wherein like reference numerals are used to refer to like elements throughout. It will be understood that the figures are not necessarily to scale.

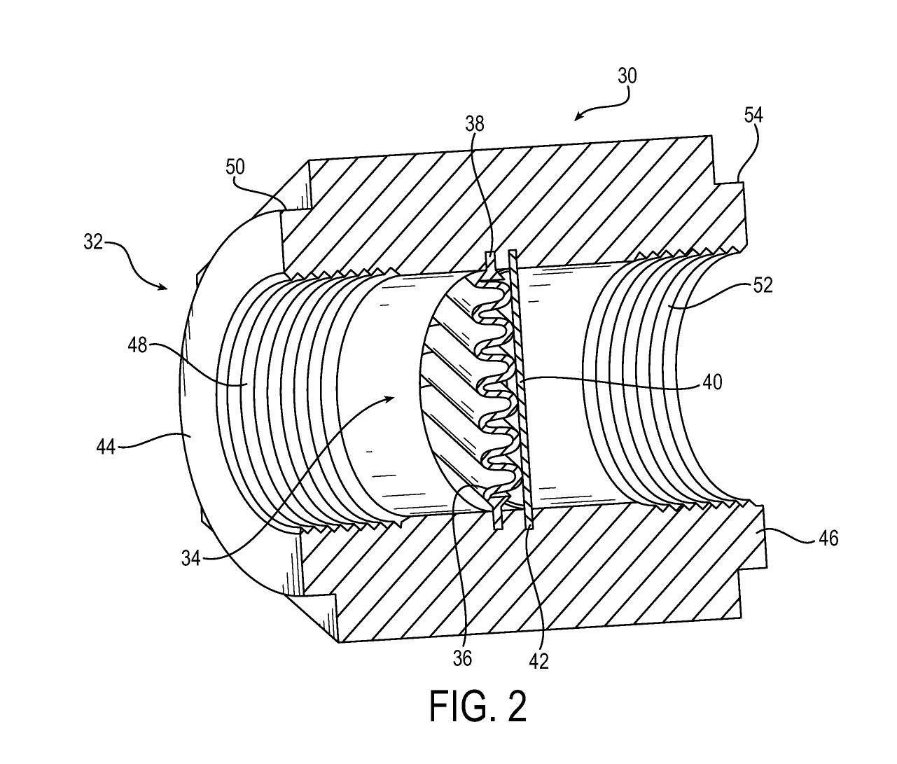

FIG. 2 is a drawing depicting an enhanced molded inline filter assembly 30 in accordance with embodiments of the present invention. In exemplary embodiments, the filter assembly 30 may include a filter housing 32 formed as a singular unitary component, rather than being constituted of separate parts as in conventional configurations. The filter assembly 30 further may include a filter element 34. In exemplary embodiments of the inline filter assembly, the filter housing may be configured as a singular unitary component having a first end and a second end different from the first end, and defining a fluid flow passage through the filter assembly. The filter element may be fixed within the filter housing and spaced apart from both of the first and second ends of the filter housing, and the filter element includes a filtering material that filters a fluid as the fluid flows between the first end and the second end of the filter housing.

Referring to FIG. 2, in exemplary embodiments, the filter element 34 may be configured as a pleated disc filter element having a plurality of folds 36. To achieve filtration, the folds 36 may constitute a metal mesh of any suitable micron configuration. For many inline filtering applications, the mesh size may range from about 10-500 microns. To achieve a desired overall micron size, the disc filter element 34 may include multiple layers each of differing mesh size. For example, in a direction of fluid flow the layers may first include a relatively coarse micron layer, and one or more finer mesh layers to achieve the desired overall mesh. In exemplary embodiments, the filter element may include three layers that are laminated or pressed together to create a solid and unitary piece.

The filter housing 32 may be made of any suitable moldable plastic material that is rigid when cooled so as to be able to accommodate the high flow rates (e.g., at least 10 gpm) of typical inline filtration applications. Moldable nylon is particularly suitable, although similar moldable plastic materials, such as thermoplastic and polymer materials, may be employed. The moldable plastic material of the housing may be molded around an anchoring portion of the filter element. For example, as shown in FIG. 2 the filter element 34 may include an anchoring portion configured as a filter extension 38 that extends into the filter housing 32, and the moldable plastic material is molded around the filter extension 38 to secure the filter element within the filter housing.

Optionally, to provide additional support for the filter element against the force or pressure of the high inline flow rates, the filter assembly 30 further may include a support disc 40. The support disc 40 may be configured as a metal disc insert (e.g., aluminum, stainless steel, or other suitable metal), made of a rigid plastic, or made of any other suitable rigid material so as to provide rigid support for the filter element. To provide such support, the support disc may be located against or adjacent to the filter element on a second side of the filter element opposite to a first side of the filter element onto which the fluid flow is incident. The support disc 40 may have spacing or large mesh so as to provide adequate support for the filter element without significantly impeding the fluid flow. The support disc further may include a disc extension 42 that extends into the filter housing 32 to secure the support disc within the filter housing, i.e., the moldable plastic material of the filter housing further may be molded around the disc extension 42 to secure the support disc within the filter housing.

The filter housing 32 may include a first end 44 and a second end 46 different from the first end. In the depicted example, the housing is essentially straight and the first and second ends are opposite to each other. The housing, however, may be configured in any shape, such as with bends, curves, or T-shaped, with the first and second ends being different from each other but not necessarily directly opposite as in the example of FIG. 2. The filter element 34 (and the optional support disc 40 if employed) may be located between the first and second ends and spaced apart from the first and second ends. In the depiction of FIG. 2, fluid flow proceeds in an axial direction from the first end to the second end, so as referenced above, the fluid flow is incident on the first side of the filter element opposite from the second side associated with the support disc 40.

Generally, the first end and/or the second end of the filter housing may have a fastening portion to connect the filter assembly to a fluid system component. Referring to FIG. 2, the first end 44 of the filter housing 32 may include a first fastening portion 48 formed on an inside surface of the filter housing. The first fastening portion 48 may be employed to connect the filter assembly 30 to a fluid system component, such as for example a pipe, tubing, hose, or fitting. As shown in the example of FIG. 2, the first fastening portion 48 may be configured as threads to screw the filter assembly onto the filter system component. Other potential configurations for the fastening portion 48 may include snap-fit ridges, hose barbs, or other suitable configuration that would permit connection to a filter system component. In the example of FIG. 2, the filter housing 32 also may have an outer ridge 50, which is shaped based on a mold configuration that is easier to produce for insert molding the filter assembly.

The second end 46 of the filter housing 32 may be configured comparably as the first end 44. For example, the second end 46 may include a second fastening portion 52 (e.g., threading or comparable) for connection to a filter system component (e.g., pipe, tubing, hose, fitting), and a second outer ridge 54 resulting from the enhanced mold configuration. When the first and/or second fastening portions are provided on an inner surface of the filter housing as shown in the example FIG. 2, the filter system component is inserted into and fastened to the inside surface of the filter housing 32. In an alternative example, one or both of the first or second fastening portions may be provided on an outer surface of the filter housing, and the filter housing would then be inserted into and fastened to an inside surface of the filter system component.

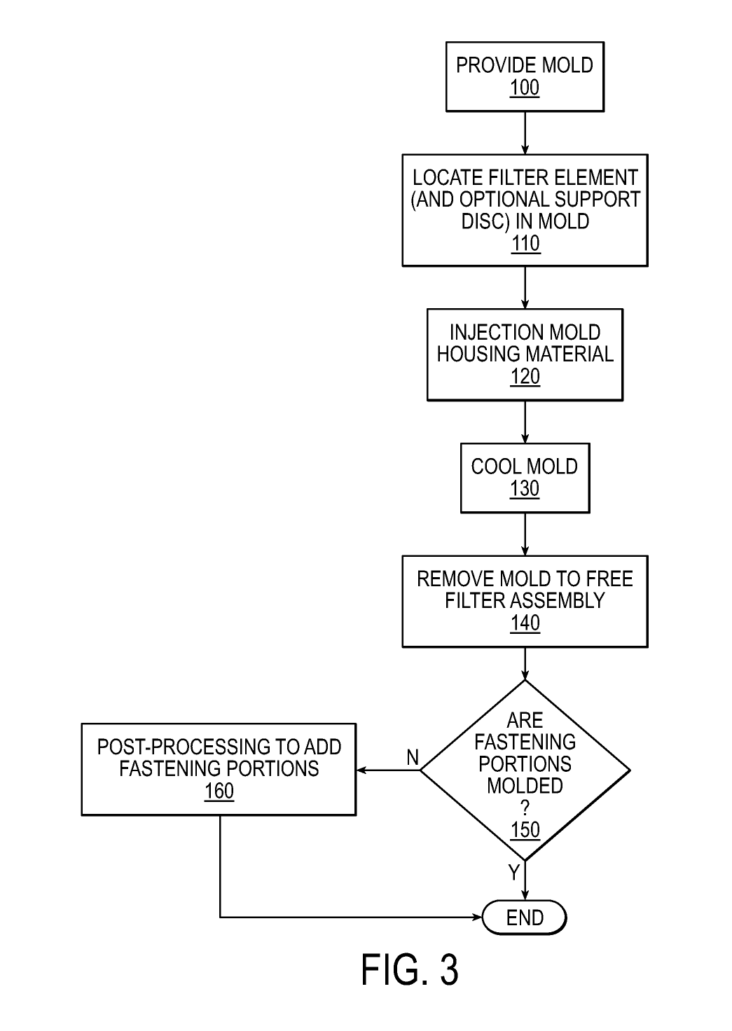

FIG. 3 is a flow chart diagram depicting an exemplary method of insert molding a filter assembly in accordance with embodiments of the present invention. Although the exemplary method is described as a specific order of executing functional logic steps, the order of executing the steps may be changed relative to the order described. Also, two or more steps described in succession may be executed concurrently or with partial concurrence. It is understood that all such variations are within the scope of the present invention. The method depicted in FIG. 3 represents an overview, and additional details are provided in connection with examples set forth below.

The method may begin at step 100 in which a mold for the filter housing is provided. The mold as is typical is inversely shaped relative to the desired form of the filter housing 32. Commensurate with the above, the filter housing mold may be configured to form the filter housing as a singular unitary component having a first end and a second end opposite from the first end, and defining a fluid flow passage through the filter assembly. In exemplary embodiments, the mold may include suitable features to form the first and/or second fastening portions 50 and 54 in at least one end of the filter housing for connecting the filter assembly to a fluid system component, and thus the fastening portion or portions may be molded into the filter housing. In an alternative method, the first and/or second fastening portions 50 and 54 may be separately formed, machined or otherwise added to the filter housing in a post-processing step after the mold is removed at the end of the specific molding process.

In a step 110, the filter element 34 may be located in the mold corresponding to where the filter element is to be fixed within the filter housing. Commensurate with the above, the filter element may include a filtering material to filter a fluid as the fluid flows between the first end and the second end of the filter housing. In exemplary embodiments that further include the support disc 40, step 110 further may include commensurately locating the support disc within the mold against or adjacent to the filter element on a second side of the filter element opposite to a first side of the filter element onto which the fluid flow is to be incident. To properly locate the filter element and optional support disc, the mold may include a guide pin to aid in proper locating of the filter element and the support disc within the mold, and the guide pin further may aid in holding the filter element and the support disc in place during the molding process.

In a step 120, molten filter housing material may be injection molded into the mold and around the filter element (and support disc if employed) such that a portion of the filter element (and support disc if employed) is encapsulated by the molten filter housing material to form the filter housing in a manner that bonds the filter element in place within the filter housing. During the molding process the perimeter of the disc filter element may be encapsulated by the molten plastic material to bond the disc filter element (and other support components) within the housing in place in a sealed fashion without the need to utilize additional sealing elements. More particularly, the molten housing material may be molded around the filter extension 38 to encompass the filter element extension 38 (and similarly as to the support extension 42) to bond the filter element and support disc in place, such that when cooled, the filter element 32 and support disc 40 are securely anchored in a sealed fashion via the extensions 38 and 42. The molded filter housing may be left open in the axial direction (i.e., in the direction of the fluid flow) to allow fluid to flow through the disc filter element. The material for molding the filter housing may be a moldable plastic material, and may in particular be moldable nylon.

In a step 130 the mold may cooled, and in a step 140 the mold may be removed to free the completed filter assembly including the filter element (and support disc if employed) fixed within the filter housing. If a guide pin is used during the molding process, the guide pin may be removed prior to removing the remainder of the mold structure.

As referenced above, at least one end of the filter housing may include a fastening portion. For example, the first and/or second fastening portions 50 and 54 of the filter housing either may be formed as part of the molding process, or may be separately machined or otherwise added to the filter housing in a post-processing step after the insert molding process that forms the filter assembly. These alternative steps of forming the fastening portions are depicted in steps 150 and 160 of FIG. 3.

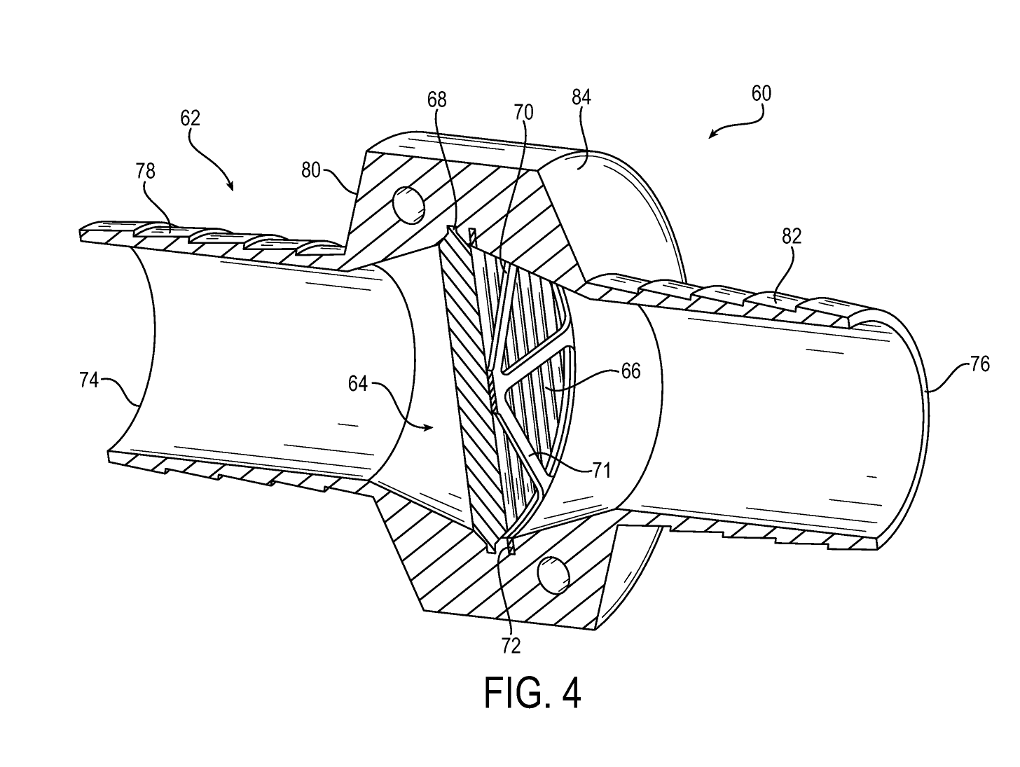

FIG. 4 is a drawing depicting another embodiment of an enhanced insert molded inline filter assembly 60 in accordance with embodiments of the present invention. The embodiment of FIG. 4 bears similarity to the embodiment of FIG. 2. In the example of FIG. 4, the filter assembly 60 may include a filter housing 62 that similarly to previous embodiments is formed as a singular unitary component, rather than being constituted of separate parts as in conventional configurations. The filter assembly 60 further may include a comparable filter element 64 having a plurality of folds 66, that may be fixed within the filter housing and spaced apart from both of the first and second ends of the filter housing. The filter element includes a filtering material that filters a fluid as the fluid flows between the first end and the second end of the filter housing. The filter element 64 and filter housing 62 may be made of comparable materials as the previous embodiments. In addition, the filter element 64 may include an anchoring portion configured as a filter extension 68 that extends into the filter housing 62, and the moldable plastic material of the filter housing is molded around the filter extension 68 to secure the filter element within the filter housing.

The filter assembly 60 also may include an optional support disc 70 comparably as above to provide additional support for the filter element against the force or pressure of the high inline flow rates. FIG. 4 shows a viewpoint directed more toward a view of the support disc. As shown in this example, the support disc may include a plurality of spokes 71 to provide support across the filter element, with a wide mesh or spacing between the spokes so as to provide adequate support for the filter element without significantly impeding the fluid flow. Other disc configurations may be employed (grid meshes or the like) so long as support is provided without significantly impeding flow. The support disc 70 may include a disc extension 72 that extends into the filter housing 62 to secure the support disc within the filter housing, i.e., the moldable plastic material of the filter housing further may be molded around the disc extension 72 to secure the support disc within the filter housing.

The filter housing 62 may include a first end 74 and a second end 76 different from the first end. Again, in the depicted example the housing is essentially straight and the first and second ends are opposite to each other. The housing, however, may be configured in any shape, such as with bends, curves, or T-shaped, with the first and second ends being different from each other but not necessarily directly opposite as in FIG. 4.

The example of FIG. 4 differs from the example of FIG. 2 in the nature of the fastening portion at the first end and/or the second end of the filter housing to connect the filter assembly to a fluid system component. Referring to FIG. 4, the first end 74 of the filter housing 62 may include a first fastening portion 78 formed in this example on an outside surface of the filter housing. The first fastening portion 78 may be employed to connect the filter assembly 60 to a fluid system component, such as for example a pipe, tubing, hose, or fitting. In the example of FIG. 4, the first fastening portion 78 may be configured as hose barbs for inserting the filter assembly end into a hose. As referenced above, other potential configurations for the fastening portion 78 may include snap-fit ridges, threads, or other suitable configurations that would permit connection to a filter system component. In the example of FIG. 4, the filter housing 62 also may have an outer ridge 80, which is shaped based on a mold configuration that is easier to produce for insert molding the filter assembly.

The second end 76 of the filter housing 62 may be configured comparably as the first end 74. For example, the second end 76 may include a second fastening portion 82 (e.g., hose barbs or comparable) for connection to a filter system component (e.g., pipe, tubing, hose, fitting), and a second outer ridge 84 resulting from the enhanced mold configuration. In both the examples of FIGS. 2 and 4, the fastening portions are the type same and are located on the same surface of the filter housing, but this not be the case. Rather, the first fastening portion may be different from the second fastening portion, in type and/or surface location (outer versus inner surface) so that different ends of the filter housing may be connected to different types of filter system components.

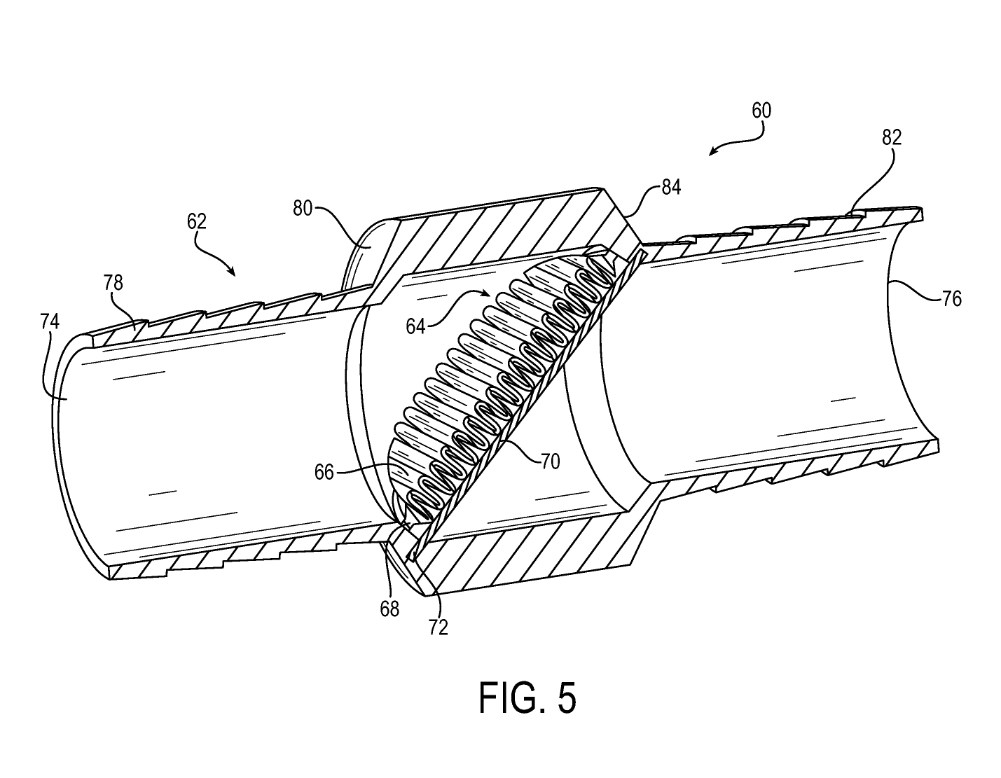

FIG. 5 is a drawing depicting yet another embodiment of an enhanced insert molded inline filter assembly in accordance with embodiments of the present invention. FIG. 5 is largely comparable to FIG. 4, and thus like components are denoted by like reference numerals. In the example of FIG. 5, the filter element 64 (and the optional support disc 70 if used) are oriented obliquely or inclined relative to an inner surface of the filter housing 62. Such an inclined configuration can reduce the impact of high flow rates on the filter element so as to reduce the support need on the filter element, which in turn can reduce the requisite size of the support disc or may eliminate the need for a support disc.

By insert molding the filter assembly components into a single structure filter assembly, the cost to produce the filter assembly can be greatly reduced. The reliability of the filter assembly is also enhanced as compared to conventional configurations that require welds, o-rings, or other sealing elements that may have threads, which can rust, fail or be damaged. In addition, insert molding the filtration components using nylon or other high performance plastics as the filter housing material can significantly reduce the weight of the assembly over conventional designs, which is advantageous for manufacturing, shipping, and assembly. A molded nylon or other plastic housing also does not rust and otherwise is highly resistant to corrosion as compared to the materials of filter housing components used in conventional configurations.

As a variation or alternative to insert molding using an injection molding process, an alternative method of manufacturing may be three dimensional (3D) printing of the filter housing as a singular unitary component around the filter element and optional support disc. The materials used in a 3D printing process are comparable as in injection molding, as a 3D printable plastic material, and nylon in particular, may be employed in a 3D printing process. Generally, a 3D printing process may include inserting the filter element (and optionally the support disc) into a 3D printer, and 3D printing the filter housing around the filter element such that a portion of the filter element is encapsulated by the filter housing material to form the filter housing in a manner that bonds the filter element in place within the filter housing.

In exemplary embodiments, a 3D printing process first may include a step of 3D printing a first portion of the filter housing. For example, up to a half of the filter housing may be 3D printed as the first portion of the filter housing. As part of the printing process, the first portion of the filter housing may include a recess for receiving an anchoring portion of the filter element, such as a recess for receiving the filter element extension 38/68 referenced above The 3D printing process may then be paused. The filter element may then be inserted into the first portion of the filter housing, such as by inserting the anchoring portion or filter extension into the recess formed in the first portion of the filter housing. The 3D printing process may then be resumed to 3D print a second portion of the filter housing to form the filter housing as a singular unitary component with the anchoring portion of the filter element being encapsulated by the filter housing.

An alternative 3D printing method may include pre-positioning the filter element within the 3D printer using a guide pin are comparable guide component similarly as in the molding process. The filter housing may then be 3D printed around the filter element such that a portion of the filter element is encapsulated by the filter housing material to form the filter housing in a manner that bonds the filter element in place within the filter housing. The guide pin may then be removed after the 3D printing process is complete.

The above 3D printing processes further may be modified for use of a support disc. For example, a the first portion of the filter housing may include a recess for receiving an anchoring portion of the support disc, such as a recess for receiving the disc extension 42/72 referenced above. The 3D printing process may then be paused. The support disc and the filter element may then be inserted into the first portion of the filter housing, such as by inserting the anchoring portions into the respective recesses formed in the first portion of the filter housing. The 3D printing process may then be resumed to 3D print the second portion of the filter housing to form the filter housing as a singular unitary component with the anchoring portions of the filter element and the support disc being encapsulated by the filter housing.

Similarly, in the alternative process the guide pin may be used to pre-position the support disc in the 3D printer. The filter housing may then be 3D printed around the filter element and support disc in combination such that a portion of the filter element and the support disc are encapsulated by the filter housing material to form the filter housing in a manner that bonds the filter element and support disc in place within the filter housing. The guide pin may then be removed.

An aspect of the invention is an inline filter assembly. In exemplary embodiments, the inline filter assembly may include a filter housing configured as a singular unitary component having a first end and a second end different from the first end, and defining a fluid flow passage through the filter assembly. A filter element is fixed within the housing and spaced apart from both of the first and second ends of the filter housing, wherein the filter element includes a filtering material that filters a fluid as the fluid flows between the first end and the second end of the filter housing. The inline filter assembly may include one or more of the following features, either individually or in combination.

In an exemplary embodiment of the inline filter assembly, the filter housing is made of a moldable plastic material that is molded around an anchoring portion of the filter element.

In an exemplary embodiment of the inline filter assembly, the anchoring portion of the filter element comprises a filter extension that extends into the filter housing to secure the filter element within the filter housing, and the moldable plastic material is molded around the filter extension.

In an exemplary embodiment of the inline filter assembly, the filter housing is made of a 3D printable plastic material that is 3D printed around an anchoring portion of the filter element.

In an exemplary embodiment of the inline filter assembly, the anchoring portion of the filter element comprises a filter extension that extends into the filter housing to secure the filter element within the filter housing, and the 3D printable plastic material is 3D printed around the filter extension.

In an exemplary embodiment of the inline filter assembly, the plastic material is nylon.

In an exemplary embodiment of the inline filter assembly, the assembly may include a support disc that is located against or adjacent to a second side of the filter element opposite to a first side of the filter element onto which the fluid flow is incident.

In an exemplary embodiment of the inline filter assembly, the support disc is configured as a metal insert.

In an exemplary embodiment of the inline filter assembly, the support disc includes a disc extension that extends into the filter housing to secure the support disc within the filter housing, and the filter housing comprises a moldable plastic material that is molded around the disc extension.

In an exemplary embodiment of the inline filter assembly, the support disc includes a disc extension that extends into the filter housing to secure the support disc within the filter housing, and the filter housing comprises a 3D printable plastic material that is 3D printed around the disc extension.

In an exemplary embodiment of the inline filter assembly, the filter element is configured as a pleated disc filter element having a plurality of folds.

In an exemplary embodiment of the inline filter assembly, the filter element comprises multiple layers of different mesh size.

In an exemplary embodiment of the inline filter assembly, the first end and/or the second end of the filter housing has a fastening portion to connect the filter assembly to a fluid system component.

In an exemplary embodiment of the inline filter assembly, the fastening portion is located on an inner surface of the filter housing.

In an exemplary embodiment of the inline filter assembly, the fastening portion is located on an outer surface of the filter housing.

In an exemplary embodiment of the inline filter assembly, the filter element is oriented obliquely relative to an inner surface of the filter housing.

In an exemplary embodiment of the inline filter assembly, the support disc is oriented obliquely relative to the inner surface of the filter housing.

In an exemplary embodiment of the inline filter assembly, the molded configuration of the inline filter assembly may include a filter element and a filter housing having a first end and a second end different from the first end, and defining a fluid flow passage through the filter assembly. The filter housing is made of a moldable plastic material that is molded as a singular unitary component around an extension portion of the filter element to secure the filter element within the filter housing, and the filter element includes a filtering material that filters a fluid as the fluid flows between the first end and the second end of the filter housing.

Another aspect of the invention is a method of insert molding a filter assembly. In exemplary embodiments, the method of insert molding may include the steps of: providing a mold shaped to form a filter housing as a singular unitary component, the filter housing mold being configured to form the filter housing having a first end and a second end different from the first end, and defining a fluid flow passage through the filter assembly; locating a filter element in the mold at a location corresponding to where the filter element is to be fixed within the filter housing, the filter element including a filtering material to filter a fluid as the fluid flows between the first end and the second end of the filter housing; injection molding molten filter housing material into the mold and around the filter element such that a portion of the filter element is encapsulated by the molten filter housing material to form the filter housing in a manner that bonds the filter element in place within the filter housing; cooling the mold; and removing the mold to free the filter assembly comprising the filter element fixed within the filter housing. The method of insert molding the filter assembly may include one or more of the following features, either individually or in combination.

In an exemplary embodiment of the method of insert molding, the filter housing material is a moldable plastic material.

In an exemplary embodiment of the method of insert molding, the filter housing material is nylon.

In an exemplary embodiment of the method of insert molding, the mold includes a guide pin to aid in locating the filter element within the mold, and the method further comprises removing the guide pin prior to removing a remainder of the mold.

In an exemplary embodiment of the method of insert molding, the method further may include molding a fastening portion into at least one end of the filter housing for connecting the filter assembly to a fluid system equipment.

In an exemplary embodiment of the method of insert molding, the method further may include forming a fastening portion into at least one end of the filter housing, in a post-processing operation after removing the mold, for connecting the filter assembly to a fluid system equipment.

In an exemplary embodiment of the method of insert molding, the method further may include locating a support disc in the mold at a location against or adjacent to the filter element on a second side of the filter element opposite to a first side of the filter element onto which the fluid flow is to be incident.

In an exemplary embodiment of the method of insert molding, the filter element includes a filter extension, and the moldable plastic material is molded around the filter extension such that the filter extension is encapsulated by the molten filter housing material to bond the filter element in place within the filter housing.

Another aspect of the invention is a method of three dimensional (3D) printing a filter assembly. In exemplary embodiments, the 3D printing method may include the steps of: locating a filter element in a 3D printer, the filter element including a filtering material to filter a fluid as the fluid flows through the filter element; and 3D printing filter housing material around the filter element such that a portion of the filter element is encapsulated by the 3D printed filter housing material to form the filter housing in a manner that bonds the filter element in place within the filter housing, the filter housing having a first end and a second end different from the first end, and defining a fluid flow passage through the filter assembly. The 3D printing method to form the filter assembly may include one or more of the following features, either individually or in combination.

In an exemplary embodiment of the 3D printing method, the method may include 3D printing a first portion of the filter housing, the first portion of the filter housing including a recess for receiving an anchoring portion of the filter assembly; pausing 3D printing; inserting the filter element into the first portion of the filter housing, wherein the anchoring portion of the filter element is received within the recess of the first portion of the filter housing; and resuming 3D printing to print a second portion of the filter housing to form the filter housing as a singular unitary component with the anchoring portion of the filter element being encapsulated by the filter housing.

In an exemplary embodiment of the 3D printing method, the first portion of the filter housing is 3D printed to include another recess for receiving an anchoring portion of a support disc; and the method may include pausing 3D printing; inserting a support disc into the first portion of the filter housing, wherein the anchoring portion of the support disc is received within the another recess of the first portion of the filter housing; and resuming 3D printing to print the second portion of the filter housing to form the filter housing as a singular unitary component with the anchoring portion of the support disc also being encapsulated by the filter housing.

In an exemplary embodiment of the 3D printing method, the housing material is nylon.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. An inline filter assembly comprising:
a filter housing configured as a singular unitary component having a first end and a second end different from the first end, and defining a fluid flow passage through the filter assembly; and
a filter element fixed within the housing and spaced apart from both of the first and second ends of the filter housing, wherein the filter element includes a filtering material that filters a fluid as the fluid flows between the first end and the second end of the filter housing.

2. The inline filter assembly of claim 1, wherein the filter housing is made of a moldable plastic material that is molded around an anchoring portion of the filter element.

3. The inline filter assembly of claim 2, wherein the anchoring portion of the filter element comprises a filter extension that extends into the filter housing to secure the filter element within the filter housing, and the moldable plastic material is molded around the filter extension.

4. The inline filter assembly of claim 2, wherein the plastic material is nylon.

5. The inline filter assembly of claim 1, further comprising a support disc that is located against or adjacent to a second side of the filter element opposite to a first side of the filter element onto which the fluid flow is incident.

6. The inline filter assembly of claim 5, wherein the support disc is configured as a metal insert.

7. The inline filter assembly of claim 5, wherein the support disc includes a disc extension that extends into the filter housing to secure the support disc within the filter housing, and the filter housing comprises a moldable plastic material that is molded around the disc extension.

8. The inline filter assembly of claim 1, wherein the filter element is configured as a pleated disc filter element having a plurality of folds.

9. The inline filter assembly of claim 1, wherein the first end and/or the second end of the filter housing has a fastening portion to connect the filter assembly to a fluid system component.

10. The inline filter assembly of claim 1, wherein the filter element is oriented obliquely relative to an inner surface of the filter housing.

11. The inline filter assembly of claim 10, further comprising a support disc that is located against or adjacent to a second side of the filter element opposite to a first side of the filter element onto which the fluid flow is incident, and the support disc is oriented obliquely relative to the inner surface of the filter housing.

12. A method of insert molding a filter assembly comprising the steps of:
providing a mold shaped to form a filter housing as a singular unitary component, the filter housing mold being configured to form the filter housing having a first end and a second end different from the first end, and defining a fluid flow passage through the filter assembly;
locating a filter element in the mold at a location corresponding to where the filter element is to be fixed within the filter housing, the filter element including a filtering material to filter a fluid as the fluid flows between the first end and the second end of the filter housing;
injection molding molten filter housing material into the mold and around the filter element such that a portion of the filter element is encapsulated by the molten filter housing material to form the filter housing in a manner that bonds the filter element in place within the filter housing;
cooling the mold; and
removing the mold to free the filter assembly comprising the filter element fixed within the filter housing.

13. The method of insert molding of claim 12, wherein the mold includes a guide pin to aid in locating the filter element within the mold, and the method further comprises removing the guide pin prior to removing a remainder of the mold.

14. The method of insert molding of claim 12, further comprising molding a fastening portion into at least one end of the filter housing for connecting the filter assembly to a fluid system equipment.

15. The method of insert molding of claim 14, further comprising forming a fastening portion into at least one end of the filter housing, in a post-processing operation after removing the mold, for connecting the filter assembly to a fluid system equipment.

16. The method of insert molding of claim 12, further comprising locating a support disc in the mold at a location against or adjacent to the filter element on a second side of the filter element opposite to a first side of the filter element onto which the fluid flow is to be incident.

17. The method of insert molding of claim 12, wherein the filter element includes a filter extension, and the moldable plastic material is molded around the filter extension such that the filter extension is encapsulated by the molten filter housing material to bond the filter element in place within the filter housing.

18. A method of three dimensional (3D) printing a filter assembly comprising the steps of:
locating a filter element in a 3D printer, the filter element including a filtering material to filter a fluid as the fluid flows through the filter element; and
3D printing filter housing material around the filter element such that a portion of the filter element is encapsulated by the 3D printed filter housing material to form the filter housing in a manner that bonds the filter element in place within the filter housing, the filter housing having a first end and a second end different from the first end, and defining a fluid flow passage through the filter assembly.

19. The 3D printing method of claim 18 comprising:
3D printing a first portion of the filter housing, the first portion of the filter housing including a recess for receiving an anchoring portion of the filter assembly;
pausing 3D printing;
inserting the filter element into the first portion of the filter housing, wherein the anchoring portion of the filter element is received within the recess of the first portion of the filter housing; and
resuming 3D printing to print a second portion of the filter housing to form the filter housing as a singular unitary component with the anchoring portion of the filter element being encapsulated by the filter housing.

20. The 3D printing method of claim 19, wherein the first portion of the filter housing is 3D printed to include another recess for receiving an anchoring portion of a support disc, and the 3D printing method further comprises:
pausing 3D printing;
inserting the support disc into the first portion of the filter housing, wherein the anchoring portion of the support disc is received within the another recess of the first portion of the filter housing; and
resuming 3D printing to print the second portion of the filter housing to form the filter housing as a singular unitary component with the anchoring portion of the support disc also being encapsulated by the filter housing.
